(19) United States
(12) Patent Application Publication
(10) Pub. No.: US 2018/0080433 A1
(43) Pub. Date: Mar. 22, 2018

(54) ADVERTISING BOARD-TYPE SAIL-TYPE RAIL-TYPE PNEUMATIC DEVICE

(71) Applicant: Muer TE, Beijing (CN)

(72) Inventors: Muer TE, Beijing (CN); Run A, Beijing (CN)

(21) Appl. No.: 15/565,316

(22) PCT Filed: Feb. 28, 2016
(86) PCT No.: PCT/IB2016/051095

§ 371 Date: Oct. 9, 2017

(30) Foreign Application Priority Data
Apr. 8, 2015 (CN) 2014107035891

(51) Int. Cl. F03D 5/02; F03D 7/06; G09F 7/22; H02S 10/12

(52) U.S. Cl. CPC F03D 5/02; H02S 10/12; G09F 7/22; F03D 7/06

(57) ABSTRACT

An advertising board-type sail-type rail-type pneumatic device comprises four portions: the first portion is a driving body portion including blades (1) and fixed seats (5); the second portion is a control portion including angle locks (6), bearings (3), one-way gears (4), one-way guide teeth (7), synchronous rods (8) and synchronous gears (9); the third portion is a transmission portion including chains (12) and rolling wheels (13); the fourth portion is a supporting portion including rails (11), synchronous rod brackets (10) and supporting columns (14). The pneumatic device has the function of outdoor advertising board and wind power generation, so that it can both supply daily power to buildings and produce advertising income. The components of blades (1), fixed seats (5), rails (11), synchronous devices, chains (12), angle locks (6), one-way guide teeth (7) and the like of the pneumatic device are also disclosed.

### TECHNICAL FIELD

The present invention is a pneumatic device, and its application relates to the field of advertising, wind power generation, and solar power generation. Belonging to advanced energy, energy saving and environmental protection and comprehensive utilization of resources.

### BACKGROUND TECHNIQUE

At present, bulletin boards and wind turbines have been widely used in our lives. Most billboards are installed in densely populated cities, and most wind turbines are installed far away from the urban wilderness, Is the traditional wind turbine occupies a large space, advertising effect of poor restrictions, and billboards installed in the rural areas of the rural areas are lost the effect of advertising, limiting the economy. If the combination of billboards and wind turbines, both to play the economic benefits of advertising, but also wind power, for use and sale, in urban and rural areas can be easily used, can bring higher economic benefits. The invention has the advantages of both billboard and wind power generation, and the technical idea is breakthrough, the design, manufacture, transportation, installation, maintenance is convenient, the production is simple, the use cost is low, and is suitable for industrial production.

### TECHNICAL PROBLEM

Traditional wind turbine industry has relatively high barriers to entry, and shafted wind power generation equipment appears to be simple, but its blade production technology is very complex and difficult to produce on a large scale. Secondly, due to the large volume of blades, Road and vehicle restrictions are more, transportation and installation and maintenance difficulties. Wind turbine stability requirements are high, to withstand a variety of extreme weather and very complex winds alternating load test, the wind cannot reach the wind speed cannot start the wind, the wind speed is too large will cause the blade wind over speed, Easy to cause damage to the blades, the wind size requirements, short blade use period, about 10 years need to replace, use, replacement and maintenance difficulties. Large wind turbine group covers an area of large, cannot enter the city, the issue of electricity needs to be incorporated into the grid to use, small wind turbines inefficient, cannot use the city, but also there are difficulties such as networking.

### PROBLEM SOLVING

### Technical solutions

The present invention employs a windsurfing track structure, both with outdoor billboards and wind power generation functions. In order to achieve the above purpose, the device through the establishment of the upper and lower two of the same shape of the closed track, many wind blades at both ends through the fixed seat mounted on the track above the fixed seat in the track can be free to slide together with the blade can slide along the track, But also can rotate around the fixed axis. When the blades between the blades to maintain the appropriate interval, with a chain connecting fixed seat, forming a closed loop, by rotating the blade, control the blade of the wind angle, control the wind on the blade thrust size. When the part of the blade in the windward state, resulting in the thrust of the blade, the other part of the blades to keep the wind state, reducing the resistance of the blade on the wind, the chain connection, making the whole blades in the wind driven in one direction. The chain produces a huge thrust, through the chain and gear bite, driven wind turbine power generation.

If the blade is pasted or printed with a certain pattern, the overall picture can be formed when people observe the whole blade from a distance, regardless of whether the blade remains moving or stationary, similar to the effect of reversing the billboard, the role.

The structure of the invention mainly comprises three main parts: the first part is a driving body part which comprises a blade composed of a blade surface, a rotating shaft, a pair of one-way bearing and a pair of unidirectional gears, and the pneumatic device comprises a plurality of blades. The blade and the rotating shaft are fixed, the rotary shaft ends are fixed with a pair of unidirectional bearings and a pair of unidirectional gears, and one-way bearing fixed on the fixed seat, one-way gear and angle lock bite. In this way, when the unidirectional gear and the angle lock are opened, the blade can rotate freely in 360 degrees relative to the fixed seat, similar to the hinges of the doors and windows; when the unidirectional gear engages with the angle lock, the blade can rotate 360 degrees in one direction. In the wind direction and the blade at an angle, you can push the blade to wind energy into kinetic energy used to drive the generator power generation.

The second part is the control part: including angle lock, synchronization device, and a pair of unidirectional teeth. Each of the two ends of the blade at both ends of the one-way gear are engaged with the angle lock, angle lock using mechanical or electronic devices, through the direction of the wind and the direction of movement of the blade, control the blade upwind angle and lock, so that the blade is no longer rotating, and the wind to form the appropriate angle The When the wind direction and the blades into the 0 or 180 degrees angle, the wind thrust maximum; when the blade and the wind into a 90 or 270 degree angle, the wind thrust is minimal, change the wind angle can improve wind energy efficiency. The pneumatic device consists of several

Synchronization devices are depending on the specific circumstances. The synchronizing device comprises a synchronizing lever and a pair of synchronous gears is fixed at both ends of the synchronizing rod. The synchronizing rod is supported by a pair of synchronous rods. The synchronizing rod is fixed with the track or the supporting column to control the synchronism of the movement of the upper and lower chains. Unidirectional guide teeth fixed in the wind surface above the track, the specific location according to the wind direction and the direction of movement of the blade, pairs of use, one-way guide teeth and blades of the one-way gear bite, one-way tooth length depends on the blade need to rotate the angle The role is to engage with a blade of the appropriate angle of rotation.

The third part is the transmission part: including fixed seat, track, chain, rolling wheel, support column and other parts. The chain includes two upper and lower legs, which are engaged with the one-way gears at both ends of the blade, and the chain is fixed on the fixed seat, and the fixed seat can move at the same time. The fixed seat has a rolling wheel inside, the external and the rotation shaft on the one-way bearing fixed, on the one hand to provide support for the blade, on the other hand with the blades along the track movement. There are also fixed angle controls of the blade angle lock, lock the blade and the wind angle, the maximum use of wind energy.

The appearance of the present invention can be adjusted according to the specific environmental conditions to adjust the orbit, and it can be applied to many complicated environments. In addition to the circular shape, the present invention can be transformed into a triangle, a rectangle, a polygon, an irregular shape; can be internal or external nesting, to adapt to a wide range.

### THE BENEFICIAL EFFECT OF THE INVENTION

### Beneficial effect

This device has a billboard function. Will be printed on each blade or paste a certain pattern, regardless of the blades to keep moving or static state, when people from the distance to observe the overall blades, you can form the overall picture, with the effect of billboards, suitable for high-rise buildings in the city and the external walls of the installation, Can generate advertising revenue.

Power is more powerful, the wind is more applicable. The wind-driven device than the traditional wind turbine windward area, the wind area of more than 3 times, wind energy utilization, power torque, power generation. No matter what kind of wind conditions, the blades always maintain a low speed, can work in strong winds, there will be no blade wind speed phenomenon, the application of a wider range of winds.

This device can take into account the solar power generation function. The use of photovoltaic power generation materials to produce blades, pneumatic devices at the same time both wind and photovoltaic power generation function, improve the comprehensive utilization rate.

This device can be widely used in urban suburbs. Compared with the traditional wind power plant, the pneumatic device covers an area of small, can be widely used in urban high-rise, power generation can be used as building daily electricity, advertising functions can become additional benefits of the building. At the same time in the suburbs and wilderness to establish large-scale wind power stations, for a wide range.

The blades of the whole device are also different from the blades of the traditional wind turbine. The blade structure is simple and can be made of hard materials, soft materials, transparent materials and composites. The blades can be printed or pasted with different materials the production of the blades can be used in the same device, designed to facilitate production. Blade size specifications, there is no long ultra-wide components, transport convenience, suitable for long-distance transport of long-distance transport vehicles, transportation, production, transportation, use the low cost.

### A BRIEF DESCRIPTION OF THE DRAWINGS

### Description of the Drawings

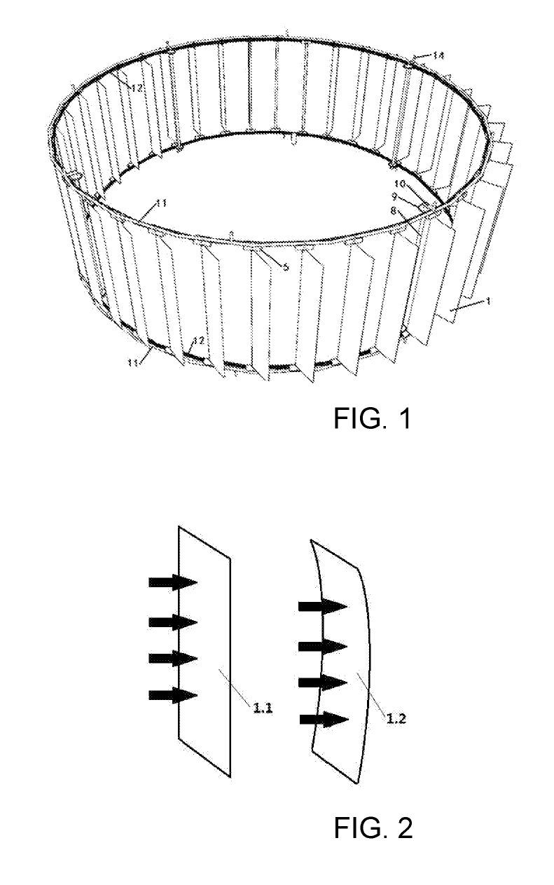

FIG. 1 is a schematic view of a device structure of the present invention. In the figure, the reference numeral 1 is the blade surface, 5 is the fixing seat, 8 is the synchronous rod, 9 is the synchronous gear, 10 is the synchronous rod holder, 11 is the track, 12 is the chain and 14 is the support column.

The main components included in the pneumatic device description:

1. Foliage: constitute the pneumatic device blade components, from the rigid, flexible, transparent material, the surface can be painted or paste the advertising screen, the main role of the wind into power.

Foliage according to the hardness classification can be divided into rigid, flexible, transparent and other materials.

FIG. 2 is a schematic view of rigid and flexible foliage, where 1.1 is rigid foliage, 1.2 is flexible foliage

Rigid foliage cannot be deformed; foliage can be divided into flat, curved dovetail and arc shape three ways.

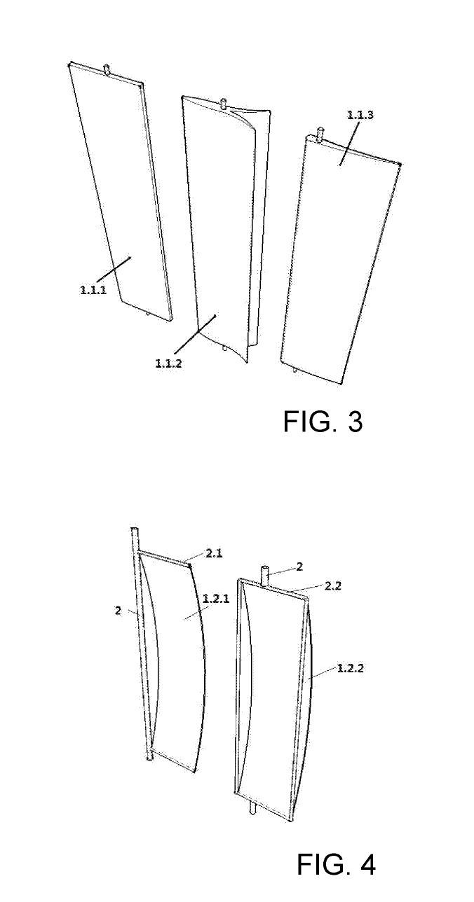

FIG. 3 is a schematic view of a rigid foliage profile in which 1.1.1 is a flat plate shape, 1.1.2 is a nitrous shape, and 1.1.3 is an arcuate shape.

Flexible foliage can be deformed under the action of wind.

FIG. 4 shows the flexible foliage, where 2 is the axis of rotation, 2.1 is the support bar, 2.2 is the support frame, 1.2.1 is the flexible blade, and 1.2.2 is the flexible blade.

2. Rotating shaft: The components that make up the blade of the pneumatic device are fixed to the foliage and provide support for the foliage, which can be rotated 360 in the axial direction.

The rotation axis of the blade may be in the form of a central axis, an eccentric shaft and an end shaft.

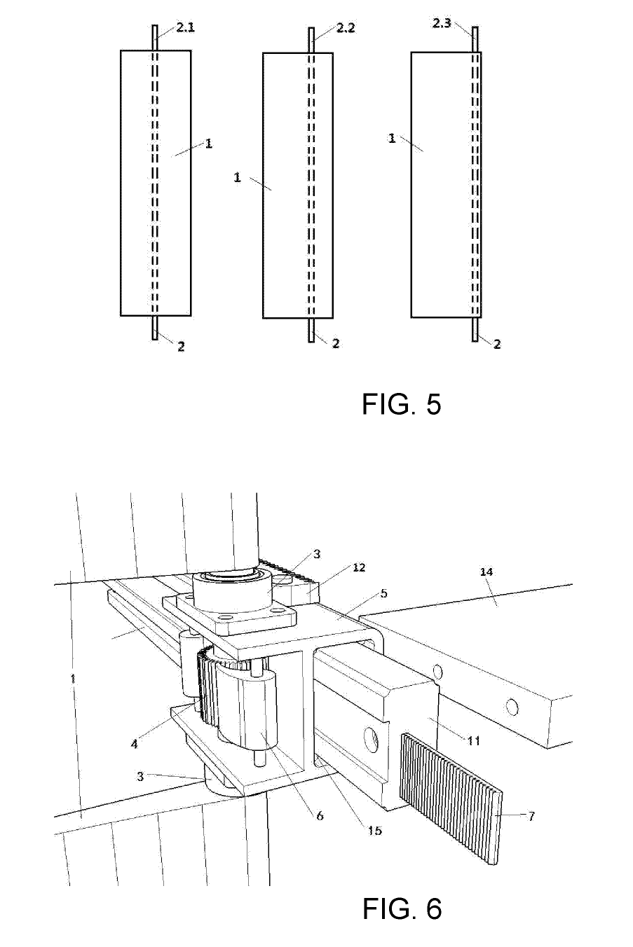

FIG. 5 is a schematic view of the rotation axis of the blade, wherein 1 is the blade surface, 2 is the rotation axis, 2.1 is the center axis, 2.2 is the eccentric shaft, and 2.3 is the end shaft.

3. One-way bearings: components that make up the blade of the pneumatic device, fixed to both ends of the rotary shaft to reduce the rotational resistance.

4. Unidirectional gears: Components that make up the blades of the pneumatic device, which are fixed in pairs with the rotary shaft and can be rotated in unidirectional rotation with the angle lock.

5. Fixed seat: can be divided into C-shaped fixed seat and upper and lower fixed seat. C-shaped fixed seat in the track, you can slide freely in the track, you can provide fixed and support for the blade;

FIG. 6 is a schematic view of a C-shaped fixed seat structure in which label 1 is a blade surface, 3 is a one-way bearing, 4 is a unidirectional gear, 5 is a fixed seat, 6 is an angle lock, 7 is a unidirectional guide tooth, Track, 12 for the chain or rack, 14 for the support column, 15 for the ball.

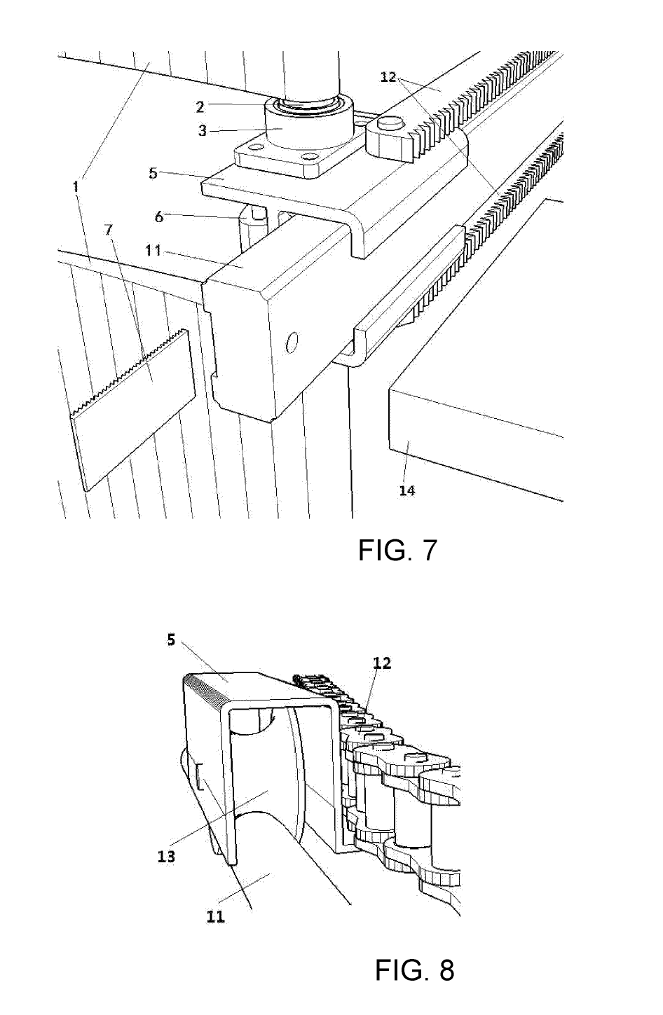

FIG. 7 is a schematic view of the angle of conversion of the C-shaped base, wherein the reference numeral 1 is the blade surface, 2 is the rotary shaft, 3 is the one-way bearing, 4 is the unidirectional gear, 5 is the fixing seat, 6 is the angle lock, For the unidirectional guide teeth, 11 for the track, 12 for the chain or rack, 14 for the support column.

Upper and lower fixed seat pressure on the track or hanging on the track, respectively, and the blades at both ends of the one-way bearing connected to the blade to provide fixed and support. A pair of upper and lower fixed seat with the use of the blade can rotate 360 around the rotation axis.

Each retainer has an inner rolling wheel or ball that allows the seat to move in orbit along the track. Fixed seat and transmission chain or rack fixed, fixed seat along the track movement, you can drive the chain or rack movement.

FIG. 8 is a schematic view of the upper and lower fixed seats, wherein 5 is a fixed seat, 11 is a track, 12 is a chain or a rack, and 13 is a rolling wheel.

6. Angle lock: the device on the fixed seat, the use of mechanical or electronic devices, pairs and one-way gear with the control of the blade upwind angle and locked, so that the blade is no longer rotating, and the wind to form the appropriate angle.

7. Unidirectional Teeth: A device that rotates a blade, fixed to a track or support column. When the blade is moving, when the unidirectional teeth are engaged with the one-way gears on the blade shaft, the blade is rotated to a specific angle and rotated The angle is determined by the length of the unidirectional tooth.

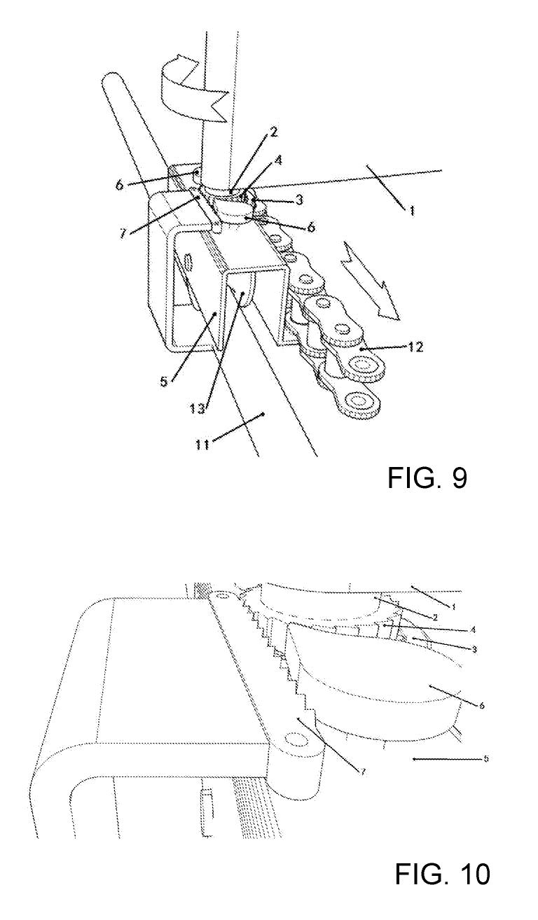

FIG. 9 is a schematic view of a one-way guide tooth structure. 1 for the rotation axis, 3 for the one-way bearing, 4 for the one-way gear, 5 for the fixed seat, 6 for the angle lock, 7 for the one-way guide teeth, 11 for the track, 12 for the chain, 13 For the rolling wheel.

FIG. 10 is a schematic view of a one-way guide tooth magnification. FIG. 1 for the blade, 2 for the rotation axis, 3 for the one-way bearing, 4 for the one-way gear, 5 for the fixed seat, 6 for the angle lock, 7 for the one-way guide teeth.

8. Synchronous rods: Components that make up the synchronous shaft made of rigid material, to keep the upper and lower chain movements of the pneumatic device synchronized.

9. Synchronous gear: the components that make up the synchronous shaft, a pair of synchronous gears fixed at both ends of the synchronous rod, engage with the upper and lower chains to control the chain synchronous movement.

10. Synchronous lever: A part that supports the synchronous shaft, which is fixed on the track or support column to provide support for the synchronous rod.

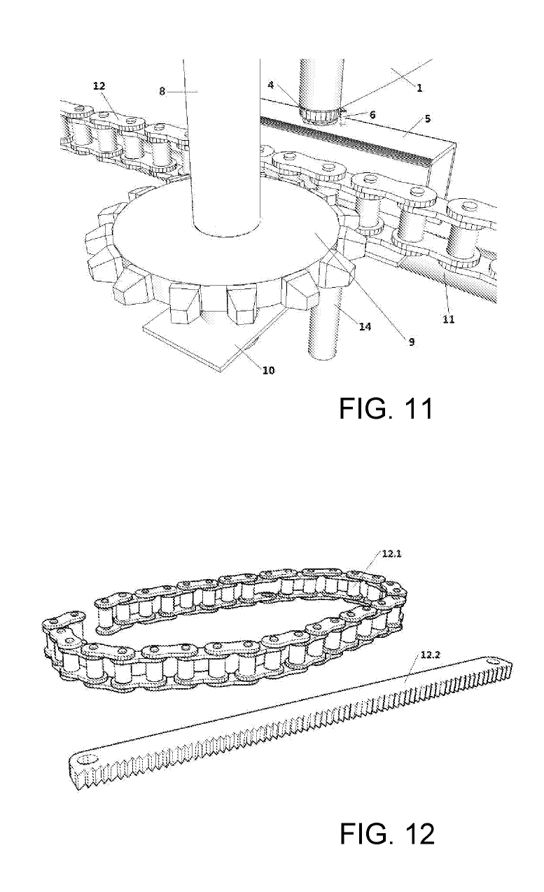

FIG. 11 is a schematic view of a synchronizing device in which label 1 is a blade surface, 4 is a unidirectional gear, 5 is a fixed seat, 6 is an angle lock, 8 is a synchronous lever, 9 is a synchronous gear, 10 is a synchronous lever, For the track, 12 for the chain, 14 for the support column.

11. Track: can be divided into single track, double track, multi-track, single track only one closed track, the blade in the upper and lower symmetrical way in the track up and down; double track with two identical shape of the track, located in the upper and lower part of the pneumatic device, Up and down two, consistent shape; multi-track is mainly formed by multi-layer nest. The track provides support and stabilization of the entire pneumatic device, allowing the blades and mounts to move in orbit.

12. Chain: The chain can be fixed with a roller chain or rack, fixed to the fixed seat, connected to the fixed seat to form a closed loop, so that the fixed seat and the blades to maintain the same speed movement, while the blade of the thrust received to the gear set.

FIG. 12 is a chain diagram, where 12.1 is a roller chain and 12.2 is a rack.

13. Rolling wheel: fixed on the fixed seat to provide support, you can scroll in the track.

14. Support column: fixed with the track, for the entire pneumatic device to provide support and fixed.

The blade 1 is the power source of the pneumatic device. Which is moved together with the holder 5 and can also be rotated 360 degrees around the longitudinal axis? By controlling the foliage of the windward angle, you can make the blade and the direction of the wind to form a suitable angle to promote the movement. The synchronizing lever 8 holds the pair of synchronizing gears 8 at both ends, and the synchronizing lever holder 10 supports the synchronizing lever 8 to keep the upper and lower drive chains 12 in synchronism.

15. Ball: Used in a C-shaped stand to provide support and slippage for a C-shaped mount.

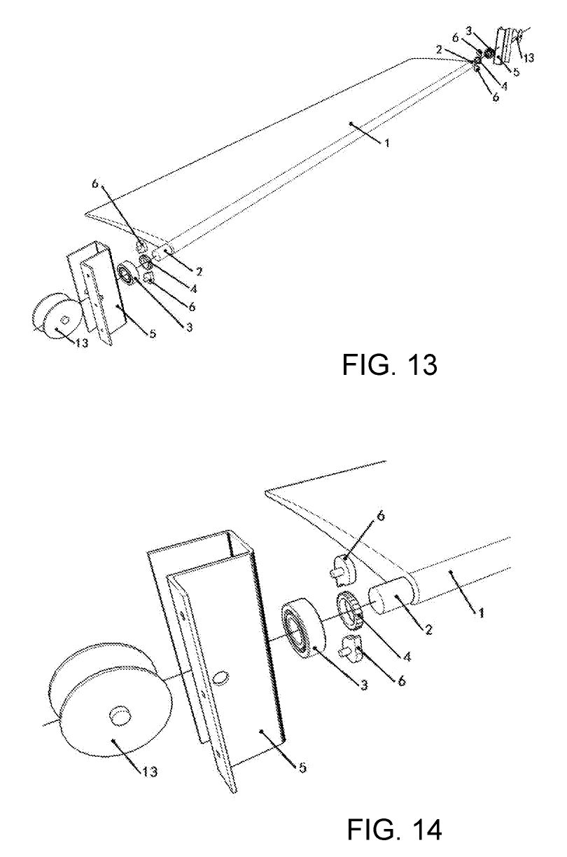

FIG. 13 is a schematic view of the blade and drive structure. FIG. 1 for the blade, 2 for the rotation axis, 3 for the one-way bearing, 4 for the one-way gear, 5 for the fixed seat, 6 for the angle lock, 13 for the rolling wheel.

FIG. 14 is an enlarged schematic view of the blade structure. FIG. 1 for the blade, 2 for the rotation axis, 3 for the one-way bearing, 4 for the one-way gear, 5 for the fixed seat, 6 for the angle lock, 13 for the rolling wheel.

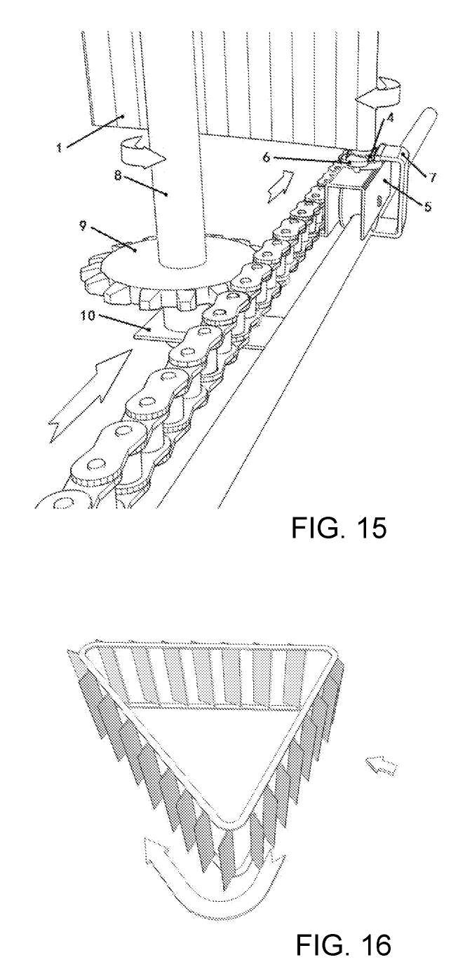

FIG. 15 is a schematic view of a synchronous axis. In the figure, reference numeral 8 denotes a synchronizing lever, 9 denote a synchronizing gear, and 10 denote a synchronizing lever. The synchronous shaft allows the chain of the upper and lower ends of the pneumatic device to remain synchronized.

FIG. 16 shows the structural intent of a triangular pneumatic device, which can be designed to be triangular according to the requirements of the environment.

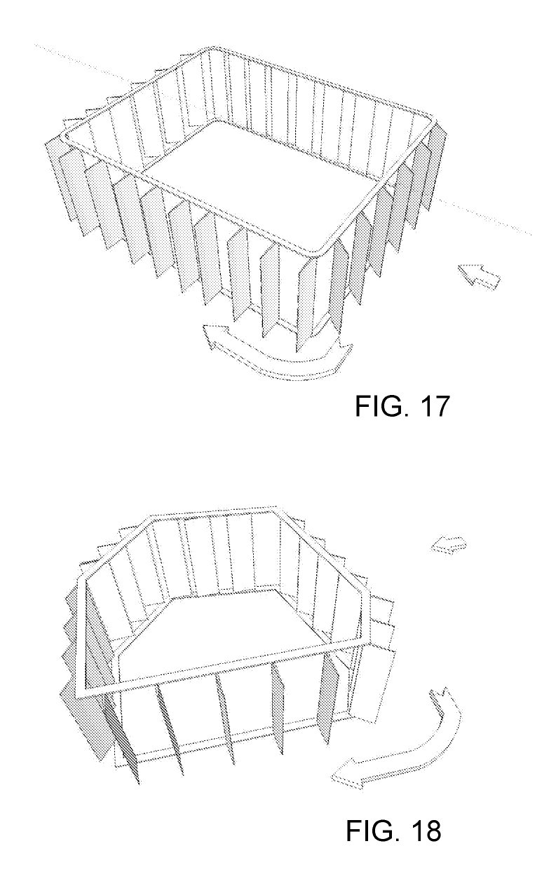

FIG. 17 is a schematic diagram of a rectangular pneumatic mechanism, which can be designed to be rectangular, and other components of a pneumatic device can be used without any adjustment, and can be used outside the roof of a high-rise building.

FIG. 18 shows a structural intention for a polygonal wind moving device, and the track can be designed as a polygon.

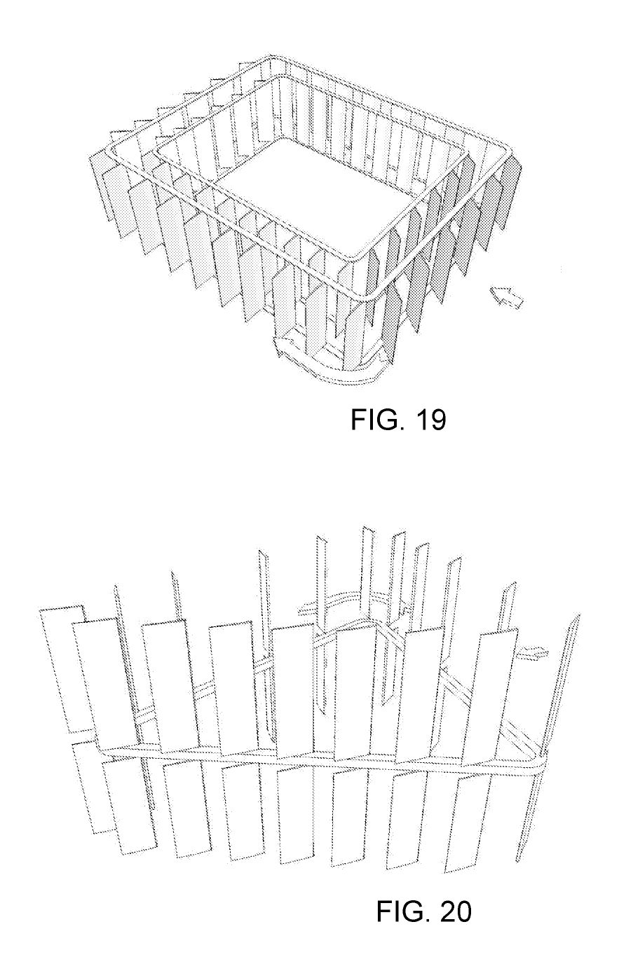

FIG. 19 is a schematic view of a pneumatic structure of a nested structure, in which the blades 1 of the inner and outer layers may be of the same size or in different sizes (this figure is shown as different sizes of blades 1). As a result of the use of structured design, the use of internal and external components can be the same, can also be multi-layer nest.

FIG. 20 is a single-track structure of a pneumatic device.

### BEST MODE FOR CARRYING OUT THE INVENTION

The present invention relates to a blade, a unidirectional bearing, a one-way bearing, an angle lock, a fixing seat, a chain, a rolling wheel, a track, a support column, a synchronous shaft, a synchronous gear, a synchronous gear carrier, Implementation is: the use of a variety of materials designed and manufactured interface consistent, a variety of blades. Track and support column manufacturing, can be modular design and manufacturing methods to produce a variety of track and support column, the track can be split into different lengths of the straight track, different radius of the curved track, through the modular combination of different Shape of the track, to adapt to the use of complex environments. Synchronous gears, synchronous gears, synchronous gears can be combined into an integral part. One-way gear, one-way bearing, angle lock, fixed seat, rolling wheel can be designed and manufactured into a complete interface with a complete component, cost savings, reduce installation steps and installation difficulty.

### INVENTIVE EXAMPLES

### Embodiments of the Present Invention

These components, such as blades, unidirectional gears, unidirectional bearings, angle locks, holders, chains, rolling wheels, tracks, support posts, synchronous shafts, synchronous gears, synchronous gears, etc., can be individually designed or manufactured. Components and components for the design and manufacture of the best practice are: blades and tracks can be designed and manufactured with different materials, track and support column can be designed and manufactured separately can also be combined design and manufacturing. Synchronous shafts, synchronous gears, synchronous gears can be individually designed and manufactured or combined with several components for design and manufacturing. Unidirectional gears, one-way bearings, angle locks, fixed seats, rolling wheels can be designed and manufactured separately. If the appropriate combination of integrated design and manufacturing will be more reasonable, cost savings, reduce the installation steps and the difficulty of the invention.

### INDUSTRIAL UTILITY

According to the preferred embodiment of the present invention, the following aspects can be designed and manufactured. The blades can be made of hard materials, soft materials, transparent materials, composite materials, etc., blades can be printed or paste the pattern material, different materials can be produced in the blades of the blade and the fixed seat has a unified interface, the same device used Design and production convenience. Blade size specifications, there is no long ultra-wide overweight parts, transport convenience, suitable for long-distance transport of long-distance transport vehicles, suitable for mass production of industrial production. Track and support columns can be modularized design and manufacturing, the track is divided into different lengths of the straight track, different radius of the curved track, easy to assemble into different shapes of the track. Support column and track combined design and manufacturing, can reduce the assembly, reduce the difficulty of installation, to facilitate large-scale industrial production. The use of integrated fixed seat design can seal gears and one-way bearings, reduce water and dust intrusion, affecting the normal operation of equipment, through a unified interface and blade connection, increase the applicability and reduce the difficulty of assembly.

Synchronous shaft, synchronous gear, synchronous gear care can be integrated design and manufacturing, suitable for industrial production.

I/we claim:

1. A billboard windmill type wind driven device characterized by a pneumatic device having a blade, a fixing seat, a track, a chain, a synchronizing device, a control device and a supporting device, the application of which relates to the field of advertising, the field of wind power generation And solar power generation field, with billboard function, wind power generation function.

2. A billboard windmill type windmill according to claim 1 having a billboard function having a billboard function having a windsurfing function which is rotatable about an axis of rotation and which can be moved in different directions The blade and the fixed seat can move along the track, you can combine the blades and LED screen to form a dynamic display screen, the blade can be drawn or paste the above pattern, regardless of whether the blade is still or moving state, can form the overall advertising screen, Ability to show ads from multiple perspectives.

3. A billboard-type windsurfing type pneumatic apparatus according to claim 1, which can be widely applied to the ground, the roof, the outside of the building, the top of the building, the surroundings of the building, etc., Appearance requirements for custom design.

4. A billboard windmill type pneumatic actuator according to claim 1, by changing the shape of the track, a circular, triangular, rectangular, irregular or the like can be formed to accommodate different environmental requirements; By changing the number of tracks, can be formed single-track blade symmetrical pneumatic devices, dual-track blade synchronous movement of the device, but also multi-track multi-layer nesting.

5. A billboard windmill type pneumatic actuator according to claim 1, comprising a blade, a fixing seat, a track, a guide tooth, a synchronous gear, a chain, a support column and the like, characterized in that the blade and the fixed seat The fixed seat can be moved in the track, the fixed seat between the chain connected to form a closed loop, when the wind on the blades, the blade can move along the track, synchronous gear control chain to maintain synchronous movement, the chain can drive wind turbine power generation.

6. A billboard windmill type track type pneumatic device according to claim 1, characterized in that it comprises four main parts: the first part is a drive body part comprising a blade, a fixing seat; the second part is a control part The third part is the transmission part, including the chain, rolling wheel and other components; the fourth part is the support part, including the track, the synchronous rod care, the first part of the gear, Support column.

7. A billboard windmill type windmill, blade, retainer, blade lock, chain, track, support post, rolling wheel, reversing tooth line, etc. according to claim 1, respectively, using a structured design, Uniform product size, spare parts uniform specifications, suitable for industrial production, production process standardization, the production process simple and efficient, suitable for large-scale production, production quality standards for easy control.

8. A blade comprising a blade surface, a rotary shaft, a unidirectional bearing, a one-way gear, characterized in that the foliage, the unidirectional gear and the unidirectional bearing are fixed to the rotary shaft and are rotatable about the rotation shaft 360. As shown in Fig.

9. A blade according to claim 8 having a billboard function, a windsurfing function, which can be made of rigid, rigid, flexible and transparent material, the rigid foliage cannot be deformed, the flexible foliage can be deformed, the foliage can be printed or Paste the pattern, the blade cross-section can be divided into flat, arc-shaped and curved dovetail three ways, the blade rotation axis can be used in the central axis, eccentric shaft and end shaft three ways, flexible pages need to support rod or support frame Fixed and supported.

10. A blade according to claim 8, which can be controlled by means of mechanical or electronic equipment to adjust the rotation angle of the unidirectional gear and adjust the blade windward angle so that the foliage forms an appropriate angle with the wind direction. When the blade surface's angle is 0 or 180 degrees, the maximum wind; when the foliage and wind direction into 90 or 270 degrees angle, the wind energy minimum.

11. A fixed seat, characterized by the above can be fixed one-way bearing, chain, angle lock, etc., can be fixed on the track or fixed or limited to the track between the track can move in accordance with the track, The ball or roller and track contact, can be C-shaped set in the track, can be pressed on the track, you can hang in the track, the seat can be moved in orbit.

12. A retainer according to claim 11, wherein the unidirectional bearing and the chain can be fixed and the unidirectional bearing is used to fix the vanes. The fasteners are connected by chains to form a closed loop, and the whole can be moved along the track.

13. A retainer according to claim 11, characterized in that it can be fitted in a track in a C-shape so that the holder cannot be disengaged from the track, and there is a ball or roller between the fixed seat and the track, Free to move.

14. A track characterized by a specific cross-section comprising a track and a support post, characterized in that the track is closed and supported and secured by means of a support post.

15. A track according to claim 14, which splits the tracks into tracks of different lengths and tracks of different turning radians, forming a different shaped track by modular combination, including circular, triangular, rectangular, Polygons, irregular shapes, etc., to adapt to the use of complex environments.

16. A track according to claim 14, which may be a single track use, a two-track dual-track use, a synchronized motion controlled by a synchronizer, and a multi-track nesting.

17. A track according to claim 14, which may be secured to the ground, the building and the top of the building with a support post.

18. A synchronizing device comprising a synchronizing lever, a synchronizing gear, and a synchronizing lever, characterized in that the synchronizing gear is fixed at a position close to both ends of the synchronizing lever and the synchronizing lever is fixed to the track or the supporting post by the synchronizing lever.

19. A synchronizing device according to claim 18, a pair of synchronizing gears fixed at both ends of the synchronizing rod, having a uniform engagement with the upper and lower chains to control the simultaneous movement of the upper and lower chains.

20. A chain, characterized in that it is mounted on a fixed seat for connecting the seat to form a closed loop, characterized in that a roller chain or a rack can be used.

21. A chain according to claim 20, having the primary effect of driving the generator or other means directly or through the gearbox, by the force generated by the chain movement.

22. An angle lock characterized in that the device is mounted on a fixed seat by means of mechanical or electronic means for controlling and locking the blade upwind angle so that the blade is no longer rotating and forms an appropriate angle with the wind direction.

23. A unidirectional guide tooth characterized in that it is fixed to an upper surface of a track or support post which acts to rotate the blade by engaging the one-way gear on the rotary shaft of the blade, and when the blade is moving along the track, when the unidirectional guide teeth are rotated with the blade When the one-way gear on the shaft engages, the blade is rotated to a specific angle, and the rotation angle of the blade is determined by the length of the unidirectional guide tooth.
